(19) United States
(12) Patent Application Publication
(10) Pub. No.: US 2026/0186397 A1
(43) Pub. Date: Jul. 2, 2026

(54) ILLUMINATION SYSTEM AND PROJECTION DEVICE

(71) Applicant: Coretronic Corporation, Hsin-Chu (TW)

(72) Inventors: Chin-Wen HUANG, Hsin-Chu (TW); Chung-An HSIEH, Hsin-Chu (TW); Pin-Jui HUANG, Hsin-Chu (TW)

(21) Appl. No.: 19/411,386

(22) Filed: Dec. 8, 2025

(30) Foreign Application Priority Data
Dec. 27, 2024 (CN) 2024119519216

(51) Int. Cl. G03B 21/20; G03B 21/00

(52) U.S. Cl. CPC G03B 21/2073; G03B 21/008; G03B 21/2013; G03B 21/2033; G03B 21/208

(57) ABSTRACT

An illumination system and a projection device are provided. The illumination system includes a light source module, a focusing component and a polarization module. The light source module provides a red light beam, a green light beam and a blue light beam. The focusing component is configured to focus the red light beam, the green light beam and the blue light beam to generate an illumination light beam and is provided with an ARC layer. The polarization state of the red light beam is a linear polarization state. After the at least one part of the green light beam passes through the polarization module, the polarization state of the at least one part of the green light beam is converted into a circular polarization state, and the at least one part of the green light beam enters the focusing component by the circular polarization state.

### CROSS REFERENCE TO RELATED APPLICATION

This application claims the priority benefit of Chinese Patent Application Serial Number 202411951921.6, filed on 27, Dec., 2024, the full disclosure of which is incorporated herein by reference.

### BACKGROUND

### Technical Field

The present disclosure is related to optical illumination technologies and is related to an illumination system and a projection device.

### Related Art

With the evolution and the innovation of optical projection technologies, the illumination system of a current projection device generally adopts three laser beams with three primary colors as light sources to generate an illumination light beam, and the light valve of the projection device converts the illumination light beam generated by the illumination system into an image light beam to project the image light beam into a screen or a wall by the projection lens of the projection device, thereby forming a projection image on the screen or the wall.

In order to improve the transmittance of the light beam, the optical lens of the illumination system or the projection lens in the existing technology is usually provided with an anti-reflection coating (ARC) layer. However, due to the poor transmittance of the current ARC layer for the longer wavelengths at a high angle of incidence, the light intensity distribution of a green laser light beam in the projection image is not consistent with the light intensity distribution of a red laser light beam in the projection image, and thus results in the influence of the color uniformity of the projection image. The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The illumination system in one embodiment of the present disclosure is configured to provide an illumination light beam and includes a light source module, a focusing component and a polarization module. The light source module is configured to provide a red light beam, a green light beam and a blue light beam. The focusing component is disposed in the travel path of the red light beam, the travel path of the green light beam and the travel path of the blue light beam. The focusing component is configured to focus the red light beam, the green light beam and the blue light beam to generate the illumination light beam and is provided with an ARC layer. The polarization module is disposed in the travel path of at least one part of the green light beam. The polarization state of the red light beam is a linear polarization state; after the at least one part of the green light beam passes through the polarization module, the polarization state of the at least one part of the green light beam is converted into a circular polarization state, and the at least one part of the green light beam enters the focusing component by the circular polarization state.

The projection device in another embodiment of the present disclosure includes the aforementioned illumination system, a light valve module and a lens module. The illumination system provides the illumination light beam. The light valve module is disposed in the travel path of the illumination light beam and is configured to convert the illumination light beam into an image light beam. The lens module is disposed in the travel path of the image light beam and is configured to project the image light beam out of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

Although the present disclosure is disclosed by the foregoing embodiments, the foregoing embodiments are not used to limit the present disclosure. A person skilled in the art may make modifications and variations on the present disclosure without departing from the spirit of the present disclosure. Hence, the scope limited by the appended claims is construed as the standard of the scope of the protection of the present disclosure.

### BRIEF DESCRIPTION OF THE DRAWINGS

FIG. 1 depicts one schematic diagram of an illumination system according to the first embodiment of the present disclosure.

FIG. 2 depicts another schematic diagram of the illumination system according to the first embodiment of the present disclosure.

FIG. 3 depicts one schematic diagram of an illumination system according to the second embodiment of the present disclosure.

FIG. 4 depicts another schematic diagram of the illumination system according to the second embodiment of the present disclosure.

FIG. 5 depicts one schematic diagram of an illumination system according to the third embodiment of the present disclosure.

FIG. 6 depicts the measuring point distribution diagram of the projection image of the illumination system of the present disclosure.

FIG. 7 depicts one schematic diagram of a projection device according to an embodiment of the present disclosure.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

The present disclosure provides an illumination system and a projection device which reduce the difference between the light intensity distribution of the green laser light beam in the projection image and the light intensity distribution of the red laser light beam in the projection image by converting the polarization state of the green light beam and thus improve the color uniformity of the projection image.

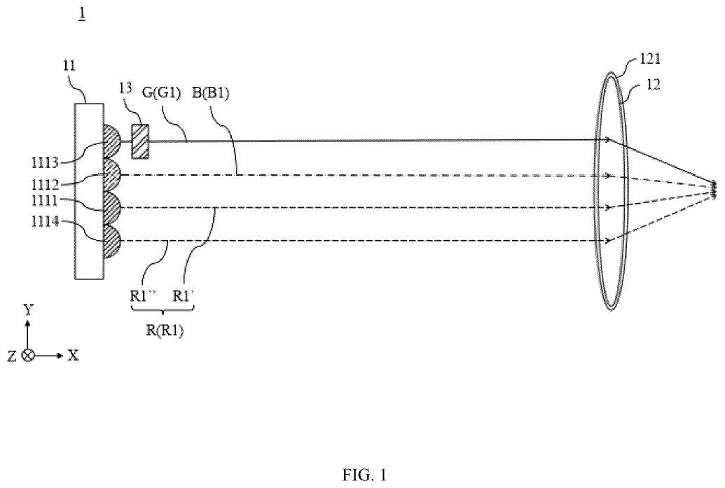

With regard to the first embodiment of the illumination system of the present disclosure, please refer to FIG. 1, wherein an illumination system 1 is configured to provide an illumination light beam and the illumination system 1 includes a light source module 11, a focusing component 12 and a polarization module 13. The light source module 11 provides a red light beam R, a green light beam G and a blue light beam B. The focusing component 12 is disposed in the travel path of the red light beam R, the travel path of the green light beam G and the travel path of the blue light beam B. The focusing component 12 is configured to focus the red light beam R, the green light beam G and the blue light beam B to generate the illumination light beam, and there is an ARC layer 121 on the light incident surface of the focusing component 12. The polarization module 13 is disposed in the travel path of at least one part of the green light beam G. The polarization state of the red light beam R is a linear polarization state; after the at least one part of the green light beam G passes through the polarization module 13, the polarization state of the at least one part of the green light beam G is converted into a circular polarization state, and the at least one part of the green light beam G enters the focusing component 12 by the circular polarization state.

Hence, the present embodiment arranges the polarization module 13 in the travel path of at least one part of the green light beam G provided by the light source module 11 so that the polarization state of the at least one part of the green light beam G is converted from the original linear polarization state to the circular polarization state after the at least one part of the green light beam G passes through the polarization module 13, and the at least one part of the green light beam G enters the focusing component 12 by the circular polarization state. By converting the polarization state of the at least one part of the green light beam G, the light intensity distribution of the green light beam G in the projection image is changed so that the light intensity distribution of the at least one part of the green light beam G in the circular polarization state in the projection image approximates to the light intensity distribution of the red light beam R in the projection image, thereby reducing the difference between the light intensity distribution of the green light beam G in the projection image and the light intensity distribution of the red light beam R in the projection image and improving the color uniformity of the projection image.

As shown in FIG. 1, in the present embodiment, the light source module 11 includes a first red sub-light source 1111, a first blue light source 1112, a first green light source 1113 and a first red compensation light source 1114. The first red sub-light source 1111, the first blue light source 1112, the first green light source 1113 and the first red compensation light source 1114 respectively provide a first red sub-light beam R1′, a first blue light beam B1, a first green light beam G1 and a first red compensation light beam R1″. The first red sub-light beam R1′ and the first red compensation light beam R1″ constitute a first red light beam R1. The red light beam R provided by the light source module 11 includes the first red light beam R1, the blue light beam B provided by the light source module 11 includes the first blue light beam B1, and the green light beam G provided by the light source module 11 includes the first green light beam G1.

For example, the first red sub-light source 1111 and the first red compensation light source 1114 may be one or more red laser diodes respectively. The first blue light source 1112 may be one or more blue laser diodes and the first green light source 1113 may be one or more green laser diodes. In the present embodiment, the light source module 11 is a laser diode array. The first red sub-light source 1111 and the first red compensation light source 1114 may be the red laser diodes respectively and be arranged in one row by a direction of crossing a paper (i.e., Z-direction) respectively. The first blue light source 1112 and the first green light source 1113 may be respectively the blue laser diodes and the green laser diodes and be separately arranged in one row by the direction of crossing the paper (i.e., Z-direction). In addition, in the Y-direction vertical to the Z-direction, the green laser diodes, the blue laser diodes, the red laser diodes of the first red sub-light source 1111 and the red laser diodes of the first red compensation light source 1114 are sequentially arranged so that each column includes one green laser diode, one blue laser diode, one red laser diode of the first red sub-light source 1111 and one red laser diode of the first red compensation light source 1114. The first red sub-light beam R1′ and the first red compensation light beam R1″ may be red laser beams respectively. The first blue light beam B1 and the first green light beam G1 may be respectively a blue laser beam and a green laser beam. The wavelength band of the first red sub-light beam R1′ and the wavelength band of the first red compensation light beam R1″ may be the same or different. The difference between the center wavelength of the first red sub-light beam R1′ and the center wavelength of the first green light beam G1 is greater than 50 nm, and the difference between the center wavelength of the first red compensation light beam R1″ and the center wavelength of the first green light beam G1 is greater than 50 nm. The difference between the center wavelength of the first green light beam G1 and the center wavelength of the first blue light beam B1 is greater than 50 nm.

In the present embodiment, the first red sub-light beam R1′, the first blue light beam B1, the first green light beam G1 and the first red compensation light beam R1″ are emitted from the light source module 11 in the same direction (i.e., X-direction). The polarization state of the first red sub-light beam R1′ provided by the light source module 11, the polarization state of the first blue light beam B1 provided by the light source module 11, the polarization state of the first green light beam G1 provided by the light source module 11 and the polarization state of the first red compensation light beam R1″ provided by the light source module 11 may be the linear polarization state of p-polarization or s-polarization respectively.

In the present embodiment, the focusing component 12 may include at least one focusing lens and focuses the first red light beam R1, the first blue light beam B1 and the first green light beam G1 to provide the focused first red light beam R1, the focused first blue light beam B1 and the focused first green light beam G1 for a subsequent light homogenizing component (not shown in figures). The light homogenizing component performs the spot shape adjustments of the light beams on the focused first red light beam R1, the focused first blue light beam B1 and the focused first green light beam G1, and the needed illumination light beam is thus generated. For example, the ARC layer 121 is formed on the surface of the focusing component 12 by a method of forming a film such as sputtering, vapor deposition or spin coating to reduce the reflection or the diffraction generated on the surface of the focusing component 12 when the light beams pass through the focusing component 12, thus improving the transmittance of the focusing component 12.

In the present embodiment, the polarization module 13 is located between the light source module 11 and the focusing component 12 and is disposed in the travel path of the first green light beam G1; in other words, the first red light beam R1 and the first blue light beam B1 don't pass through the polarization module 13. Hence, the polarization state of the first green light beam G1 is converted from the original linear polarization state to the circular polarization state after the first green light beam G1 passes through the polarization module 13, and the first green light beam G1 enters the focusing component 12 by the circular polarization state. On the contrary, the first red light beam R1 and the first blue light beam B1 respectively enter the focusing component 12 by the original linear polarization state. Considering that the ARC layer 121 has different transmittance for the light beams with the different polarization states, the polarization state of the first green light beam G1 is converted, and the light intensity distribution of the first green light beam G1 in the projection image is changed. Thus, the light intensity distribution of the first green light beam G1 in the projection image approximates to the light intensity distribution of the first red light beam R1 in the projection image, and still further, the difference between the light intensity distribution of the first green light beam G1 in the projection image and the light intensity distribution of the first red light beam R1 in the projection image is reduced, and the color uniformity of the projection image is improved.

In the present embodiment, the polarization module 13 may include at least one polarization component, and the at least one polarization component may be a quarter wave plate (QWP). The QWP may be a quartz prism with two refraction indexes or an optical component having a film with two refraction indexes.

Generally, human vision is sensitive to green light; hence, in the present embodiment, the light intensity distribution of the first green light beam G1 in the projection image is merely adjusted, and the experience of the color uniformity of the projection image for human eyes may be improved. However, the present disclosure is not limited to thereto; in the present disclosure, the polarization state of the red light beam R entering the focusing component 12 is the linear polarization state, the polarization state of the at least one part of the green light beam G entering the focusing component 12 is the circular polarization state, and the polarization state of the blue light beam B entering the focusing component 12 is the circular polarization state or the linear polarization state. In other embodiments, in addition to changing the light intensity distribution of the green light beam in the projection image by converting the polarization state of the green light beam, the light intensity distribution of the blue light beam in the projection image may be also adjusted to improve the color uniformity of the projection image.

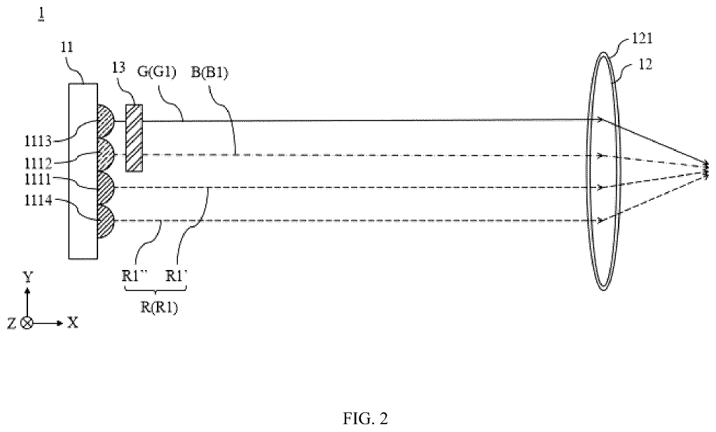

Please refer to FIG. 2. In the present embodiment, the polarization module 13 may be further disposed in the travel path of the blue light beam B1 between the light source module 11 and the focusing component 12. After the first blue light beam B1 passes through the polarization module 13, the polarization state of the first blue light beam B1 is converted from the original linear polarization state to the circular polarization state so that the first blue light beam B1 enters the focusing component 12 by the circular polarization state. By the foregoing configuration, the light intensity distribution of the first blue light beam B1 in the projection image approximates to the light intensity distribution of the first red light beam R1 in the projection image, and the color uniformity of the projection image is further improved.

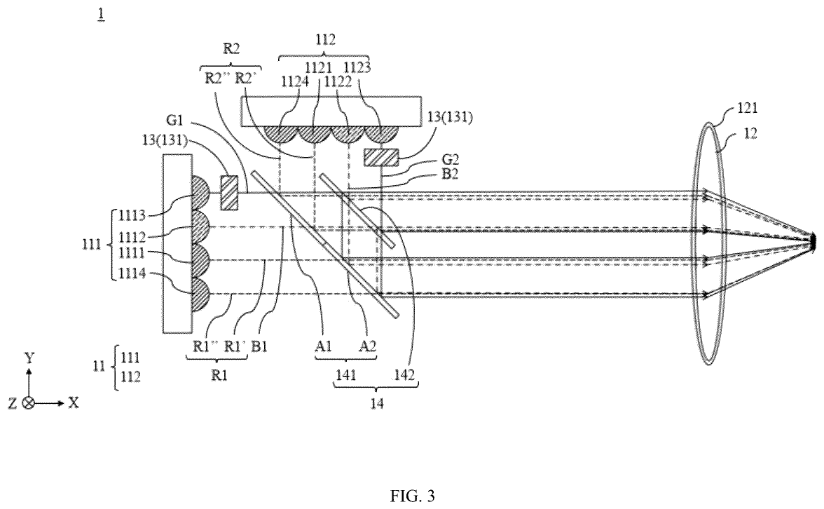

With regard to the second embodiment of the illumination system of the present disclosure, please refer to FIG. 3. The main technical content of the second embodiment is broadly similar to the main technical content of the aforementioned first embodiment (as shown in FIG. 1 and FIG. 2), and the difference between the second embodiment and the first embodiment as follows: the illumination system 1 further includes a light combining module 14, and the light source module 11 further includes a first light source module 111 and a second light source module 112. The first light source module 111 and the second light source module 112 are similar to the light source module 11 of the first embodiment respectively, and the similarities between the first light source module 111, the second light source module 112 and the light source module 11 would not be repeated herein.

In the present embodiment, the first light source module 111 includes the said first red sub-light source 1111, the said first blue light source 1112, the said first green light source 1113 and the said first red compensation light source 1114. The first light source module 111 is configured to provide the first red light beam R1, the first blue light beam B1 and the first green light beam G1. The first red light beam R1 includes the first red sub-light beam R1′ provided by the first red sub-light source 1111 and the first red compensation light beam R1″ provided by the first red compensation light source 1114. Similarly, the second light source module 112 includes a second red sub-light source 1121, a second blue light source 1122, a second green light source 1123 and a second red compensation light source 1124. The second light source module 112 is configured to provide a second red light beam R2, a second blue light beam B2 and a second green light beam G2. The second blue light source 1122 and the second green light source 1123 respectively provide the second blue light beam B2 and the second green light beam G2. The second red light beam R2 includes the second red sub-light beam R2′ provided by the second red sub-light source 1121 and the second red compensation light beam R2″ provided by the second red compensation light source 1124. The red light beam R provided by the light source module 11 includes the first red light beam R1 and the second red light beam R2, the blue light beam B provided by the light source module 11 includes the first blue light beam B1 and the second blue light beam B2, and the green light beam G provided by the light source module 11 includes the first green light beam G1 and the second green light beam G2.

The light combining module 14 is disposed in the travel path of the red light beam R between the light source module 11 and the focusing component 12, the travel path of the green light beam G between the light source module 11 and the focusing component 12 and the travel path of the blue light beam B between the light source module 11 and the focusing component 12. In the present embodiment, the light combining module 14 is located between the first light source module 111 and the focusing component 12. Moreover, the light combining module 14 is disposed in the travel path of the first red sub-light beam R1′ between the first light source module 111 and the focusing component 12, the travel path of the first red compensation light beam R1″ between the first light source module 111 and the focusing component 12, the travel path of the first green light beam G1 between the first light source module 111 and the focusing component 12, and the travel path of the first blue light beam B1 between the first light source module 111 and the focusing component 12, and is also disposed in the travel path of the second red sub-light beam R2′ between the second light source module 112 and the focusing component 12, the travel path of the second red compensation light beam R2″ between the second light source module 112 and the focusing component 12, the travel path of the second green light beam G2 between the second light source module 112 and the focusing component 12, and the travel path of the second blue light beam B2 between the second light source module 112 and the focusing component 12. The light combining module 14 is configured to guide the first red sub-light beam R1′, the first red compensation light beam R1″, the second red sub-light beam R2′, the second red compensation light beam R2″, the first green light beam G1, the second green light beam G2, the first blue light beam B1 and the second blue light beam B2 to the focusing component 12. The first light source module 111 and the second light source module 112 are respectively located on two adjacent sides of the light combining module 14, and the at least one polarization component 131 of the polarization module 13 is disposed between the first light source module 111 and the light combining module 14 and/or between the second light source module 112 and the light combining module 14.

As shown in FIG. 3, in the present embodiment, the second light source module 112 and the first light source module 111 are exhibited as a vertical arrangement. Specifically, the second red sub-light beam R2′, the second blue light beam B2, the second green light beam G2 and the second red compensation light beam R2″ are emitted from the second light source module 112 in the same direction (i.e., −Y-direction). Moreover, the direction (i.e., −Y-direction) where the second red sub-light beam R2′, the second blue light beam B2, the second green light beam G2 and the second red compensation light beam R2″ are incident in the light combining module 14 is perpendicular to the direction (i.e., X-direction) where the first red sub-light beam R1′, the first blue light beam B1, the first green light beam G1 and the first red compensation light beam R1″ are incident in the light combining module 14. In other words, the light exit direction of the first light source module 111 is perpendicular to the light exit direction of the second light source module 112. The polarization state of the first red sub-light beam R1′ provided by the first light source module 111, the polarization state of the first red compensation light beam R1″ provided by the first light source module 111, the polarization state of the second red sub-light beam R2′ provided by the second light source module 112, the second red compensation light beam R2″ provided by the second light source module 112, the polarization state of the first green light beam G1 provided by the first light source module 111, the polarization state of the second green light beam G2 provided by the second light source module 112, the polarization state of the first blue light beam B1 provided by the first light source module 111 and the polarization state of the second blue light beam B2 provided by the second light source module 112 may be the linear polarization state of p-polarization or s-polarization respectively.

In the present embodiment, the at least one polarization component 131 may be provided in two, and the two polarization components 131 are respectively disposed between the first light source module 111 and the light combining module 14 and between the second light source module 112 and the light combining module 14 so that the two polarization components 131 are respectively disposed in the travel path of the green light beam G1 between the first light source module 111 and the light combining module 14 and the travel path of the second green light beam G2 between the second light source module 112 and the light combining module 14. In other embodiments, when the at least one polarization component 131 of the polarization module 13 is merely provided in one, the polarization component 131 may be disposed between the first light source module 111 and the light combining module 14 or between the second light source module 112 and the light combining module 14. The at least one polarization component 131 would not be disposed in the travel path of the red light beam R.

Thus, after the first green light beam G1 and/or the second green light beam G2 passes through the polarization component 131, the polarization state of the first green light beam G1 and/or the polarization state of the second green light beam G2 is converted from the original linear polarization state to the circular polarization state by the polarization component 131 so that the first green light beam G1 and/or the second green light beam G2 after passing through the polarization component 131 enters the focusing component 12 by the circular polarization state, and still further, the difference between the light intensity distribution of the first green light beam G1 in the projection image and the light intensity distribution of the red light beam R in the projection image and/or the difference between the light intensity distribution of the second green light beam G2 in the projection image and the light intensity distribution of the red light beam R in the projection image is reduced, and the color uniformity of the projection image is improved.

As shown in FIG. 3, in the present embodiment, the light combining module 14 further includes a first optical component 141 and a second optical component 142. The first optical component 141 is located between the first light source module 111 and the focusing component 12, and the second optical component 142 is located between the first optical component 141 and the focusing component 12.

In the present embodiment, the first optical component 141 includes a first region A1 and a second region A2 which are adjacent to each other. The first region A1 is disposed in the travel path of the first blue light beam B1, the travel path of the first green light beam G1, the travel path of the second red sub-light beam R2′ and the travel path of the second red compensation light beam R2″. The second region A2 is disposed in the travel path of the first red sub-light beam R1′, the travel path of the first red compensation light beam R1″, the travel path of the second blue light beam B2 and the travel path of the second green light beam G2. In the present embodiment, the first region A1 may be a dichroic mirror with red reflection (DMR). The first region A1 is configured to reflect the second red light beam R2 from the second light source module 112 (i.e., the second red sub-light beam R2′ and the second red compensation light beam R2″) and to allow the first blue light beam B1 and the first green light beam G1 from the first light source module 111 to pass through. The second region A2 is configured to allow the first red light beam R1 from the first light source module 111 (i.e., the first red sub-light beam R1′ and the first red compensation light beam R1″) to pass through. After passing through the second region A2 of the first optical component 141, the first red light beam R1 (i.e., the first red sub-light beam R1′ and the first red compensation light beam R1″) travels to the focusing component 12 in the X-direction. In the present embodiment, the second optical component 142 is disposed in the travel path of the first blue light beam B1, the travel path of the first green light beam G1, the travel path of the second red sub-light beam R2′, the travel path of the second red compensation light beam R2″, the travel path of the second blue light beam B2 and the travel path of the second green light beam G2. The second optical component 142 may be a half mirror with green and blue (HMGB). The second optical component 142 is configured to reflect the first part of the first blue light beam B1 from the first light source module 111, the first part of the first green light beam G1 from the first light source module 111, the first part of the second blue light beam B2 from the second light source module 112 and the first part of the second green light beam G2 from the second light source module 112 and to allow the second part of the first blue light beam B1 from the first light source module 111, the second part of the first green light beam G1 from the first light source module 111, the second part of the second blue light beam B2 from the second light source module 112 and the second part of the second green light beam G2 from the second light source module 112 to pass through. The first part of the blue light beam B includes the first part of the first blue light beam B1 and the first part of the second blue light beam B2. The first part of the green light beam G includes the first part of the first green light beam G1 and the first part of the second green light beam G2. The second part of the blue light beam B includes the second part of the first blue light beam B1 and the second part of the second blue light beam B2. The second part of the green light beam G includes the second part of the first green light beam G1 and the second part of the second green light beam G2. For example, a blue-green semi-reflective mirror which reflects 50% blue-green light and allows 50% blue-green light to transmit may serve as the second optical component 142. Hence, the first part and the second part of the first blue light beam B1 are 50% first blue light beam B1 respectively, the first part and the second part of the first green light beam G1 are 50% first green light beam G1 respectively; the first part and the second part of the second blue light beam B2 are 50% second blue light beam B2 respectively, and the first part and the second part of the second green light beam G2 are 50% second green light beam G2 respectively. However, in other embodiments, the blue-green semi-reflective mirror with different reflectivity and different transmittance may serve as the second optical component 142, and the second optical component 142 is not limited thereto.

Furthermore, the first green light beam G1 and the first blue light beam B1 from the first light source module 111 enter the second optical component 142 after passing through the first region A1 of the first optical component 141. The second part of the first green light beam G1 and the second part of the first blue light beam B1 after passing through the second optical component 142 travel to the focusing component 12 in the X-direction, and the first part of the first blue light beam B1 and the first part of the first green light beam G1 reflected by the second optical component 142 travel to the second region A2 of the first optical component 141 in the −Y-direction. After the second blue light beam B2 and the second green light beam G2 from the second light source module 112 enter the second optical component 142, the second part of the second blue light beam B2 and the second part of the second green light beam G2 after passing through the second optical component 142 travel to the second region A2 of the first optical component 141 in the −Y-direction, and the first part of the second blue light beam B2 and the first part of the second green light beam G2 reflected by the second optical component 142 travel to the focusing component 12 in the X-direction. In addition, the second optical component 142 may also allow the second red sub-light beam R2′ and the second red compensation light beam R2″ from the second light source module 112 to pass through. Specifically, the second red sub-light beam R2′ and the second red compensation light beam R2″ from the second light source module 112 pass through the second optical component 142 and travel to the focusing component 12 in the X-direction after being reflected by the first region A1 of the first optical component

In the present embodiment, the second region A2 of the first optical component 141 is configured to reflect the first part of the first blue light beam B1, the first part of the first green light beam G1, the second part of the second blue light beam B2 and the second part of the second green light beam G2 from the second optical component 142. Furthermore, the first part of the first blue light beam B1 and the first part of the first green light beam G1 which are reflected by the second optical component 142 to travel to the second region A2 of the first optical component 141 are reflected by the second region A2 of the first optical component 141 and travel to the focusing component 12 in the X-direction. The second part of the second blue light beam B2 and the second part of the second green light beam G2 after passing through the second optical component 142 are reflected by the second region A2 of the first optical component 141 and travel to the focusing component 12 in the X-direction. In the present embodiment, the second region A2 may be a dichroic mirror with blue and green reflection (DMBG).

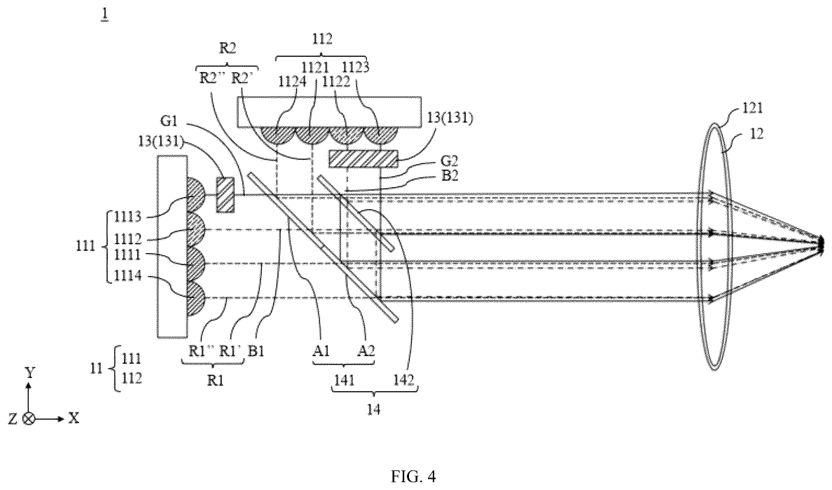

Please refer to FIG. 4. In one embodiment, the at least one polarization component 131 may be further disposed in the travel path of the first blue light beam B1 between the first light source module 111 and the light combining module 14 and/or the travel path of the second blue light beam B2 between the second light source module 112 and the light combining module 14. FIG. 4 exemplarily illustrates that the at least one polarization component 131 is disposed in the travel path of the second blue light beam B2 but is not limited thereto. After the first blue light beam B1 and/or the second blue light beam B2 passes through the at least one polarization component 131, the polarization state of the first blue light beam B1 and/or the polarization state of the second blue light beam B2 is converted from the original linear polarization state to the circular polarization state by the polarization component 131, and the first blue light beam B1 and/or the second blue light beam B2 enters the focusing component 12 by the circular polarization state. By the foregoing configuration, the light intensity distribution of the first blue light beam B1 in the projection image and/or the light intensity distribution of the second blue light beam B2 in the projection image approximates to the light intensity distribution of the red light beam R in the projection image, and the color uniformity of the projection image is further improved.

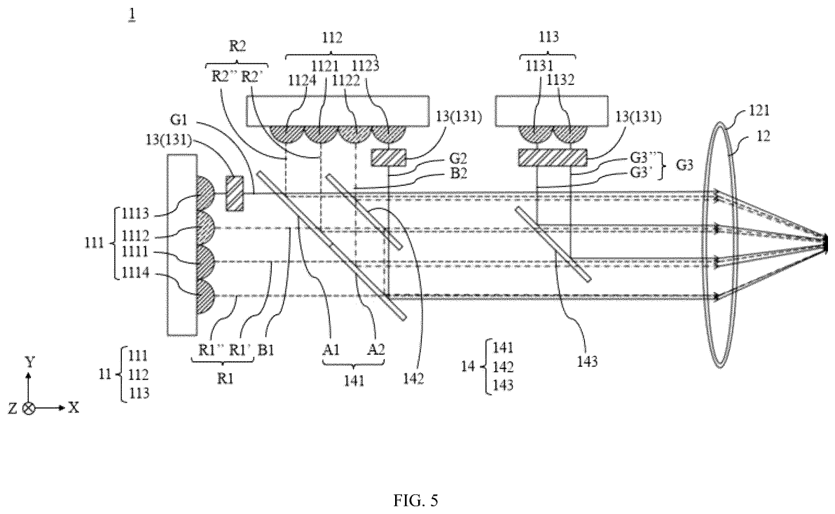

With regard to the third embodiment of the illumination system of the present disclosure, please refer to FIG. 5. The main technical content of the third embodiment is broadly similar to the main technical content of the aforementioned second embodiment (as shown in FIG. 3 and FIG. 4), and the difference between the third embodiment and the second embodiment is the different configuration of the illumination system 1. In the present embodiment, the light source module 11 of the illumination system 1 further includes a third light source module 113 in addition to the first light source module 111 and the second light source module 112. The similarities between the first light source module 111 and the second light source module 112 shown in FIG. 3 and the first light source module 111 and the second light source module 112 shown in FIG. 5 would not be repeated herein.

The third light source module 113 is configured to provide a third green light beam G3. The green light beam G provided by the light source module 11 includes the first green light beam G1, the second green light beam G2 and the third green light beam G3. Moreover, the third light source module 113 and the second light source module 112 are located on the same side of the light combining module 14, and the light combining module 14 is configured to guide the third green light beam G3 to the focusing component 12. At least one of the place between the first light source module 111 and the light combining module 14, the place between the second light source module 112 and the light combining module 14, and the place between the third light source module 113 and the light combining module 14 is provided to dispose the at least one polarization component 131.

In the present embodiment, the third light source module 113 and the second light source module 112 are disposed along the X-direction. The third light source module 113 includes a green sub-light source 1131 and a green compensation light source 1132. The green sub-light source 1131 and the green compensation light source 1132 respectively provide a green sub-light beam G3′ and a green compensation light beam G3″. The third green light beam G3 includes the green sub-light beam G3′ provided by the green sub-light source 1131 and the green compensation light beam G3″ provided by the green compensation light source 1132. The green sub-light source 1131 and the green compensation light source 1132 may be a plurality of green laser diodes respectively and be arranged in one row by the direction of crossing the paper (i.e., Z-direction) respectively. The polarization state of the green sub-light beam G3′ provided by the third light source module 113 and the polarization state of the green compensation light beam G3″ provided by the third light source module 113 may be the linear polarization state of the p-polarization or the s-polarization respectively. In the present embodiment, like the light exit direction of the second light source module 112, the green sub-light beam G3′ and the green compensation light beam G3″ of the third light source module 113 are emitted from the third light source module 113 in the same direction (i.e., −Y-direction). The direction where the green sub-light beam G3′ and the green compensation light beam G3″ are incident on the light combining module 14 is parallel to the direction where the second red sub-light beam R2′, the second green light beam G2, the second blue light beam B2 and the second red compensation light beam R2″ are incident on the light combining module 14 (i.e., −y-direction). Given the foregoing structure, when the at least one polarization component 131 is provided in three, the three polarization components 131 may be respectively disposed between the first light source module 111 and the light combining module 14, between the second light source module 112 and the light combining module 14, and between the third light source module 113 and the light combining module 14 so that the three polarization components 131 are respectively disposed in the travel path of the first green light beam G1 between the first light source module 111 and the light combining module 14, the travel path of the second green light beam G2 between the second light source module 112 and the light combining module 14, the travel path of the green sub-light beam G3′ between the third light source module 113 and the light combining module 14 and the travel path of the green compensation light beam G3″ between the third light source module 113 and the light combining module 14. When the at least one polarization component 131 is provided in two, two of the place between the first light source module 111 and the light combining module 14, the place between the second light source module 112 and the light combining module 14, and the place between the third light source module 113 and the light combining module 14 are provided to dispose the two polarization components 131. When the at least one polarization component 131 is provided in one, one of the place between the first light source module 111 and the light combining module 14, the place between the second light source module 112 and the light combining module 14, and the place between the third light source module 113 and the light combining module 14 is provided to dispose the polarization component 131. Similarly, the at least one polarization component 131 may be further disposed in the travel path of the first blue light beam B1 between the first light source module 111 and the light combining module 14 and/or the travel path of the second blue light beam B2 between the second light source module 112 and the light combining module 14, and the detailed configuration thereof would not be repeated herein.

In the present embodiment, the difference between the third embodiment and the second embodiment as follows: the second optical component 142 of the light combining module 14 may be a half mirror with blue (HMB). The second optical component 142 is configured to reflect the first part of the first blue light beam B1 from the first light source module 111 and the first part of the second blue light beam B2 from the second light source module 112, and to allow the second part of the first blue light beam B1 from the first light source module 111 and the second part of the second blue light beam B2 from the second light source module 112 to pass through. The first part of the blue light beam B includes the first part of the first blue light beam B1 and the first part of the second blue light beam B2. The second part of the blue light beam B includes the second part of the first blue light beam B1 and the second part of the second blue light beam B2. For example, a blue semi-reflective mirror which reflects 50% blue light and allows 50% blue light to transmit may serve as the second optical component 142. Hence, the first part and the second part of the first blue light beam B1 are 50% first blue light beam B1 respectively, and the first part and the second part of the second blue light beam B2 are 50% second blue light beam B2 respectively. However, in other embodiments, the blue semi-reflective mirror with different reflectivity and different transmittance may serve as the second optical component 142, and the second optical component 142 is not limited thereto. Moreover, the second optical component 142 is configured to allow the first green light beam G1 from the first light source module 111, the second red sub-light beam R2′ from the second light source module 112, the second red compensation light beam R2″ from the second light source module 112 and the second green light beam G2 from the second light source module 112 to pass through.

Furthermore, the first blue light beam B1 and the first green light beam G1 from the first light source module 111 enters the second optical component 142 after passing through the first region A1 of the first optical component 141. The first green light beam G1 and the second part of the first blue light beam B1 after passing through the second optical component 142 travel to the focusing component 12 in the X-direction, and the first part of the first blue light beam B1 reflected by the second optical component 142 travels to the second region A2 of the first optical component 141 in the −Y-direction. After the second blue light beam B2 and the second green light beam G2 from the second light source module 112 enter the second optical component 142, the second green light beam G2 and the second part of the second blue light beam B2 after passing through the second optical component 142 travel to the second region A2 of the first optical component 141 in the −Y-direction, and the first part of the second blue light beam B2 reflected by the second optical component 142 travels to the focusing component 12 in the X-direction.

In the present embodiment, the second region A2 of the first optical component 141 is configured to reflect the first part of the first blue light beam B1, the second part of the second blue light beam B2 and the second green light beam G2 from the second optical component 142.

As shown in FIG. 5, in the present embodiment, the light combining module 14 further includes a third optical component 143. The third optical component 143 is located between the second optical component 142 and the focusing component 12 and is disposed in the travel path of the green sub-light beam G3′ and the travel path of the green compensation light beam G3″. The third optical component 143 is configured to reflect the green sub-light beam G3′ and the green compensation light beam G3″ and to allow the first red sub-light beam R1′ from the first light source module 111, the second red sub-light beam R2′ from the second light source module 112, the second part of the first blue light beam B1 and the second part of the second blue light beam B2 from the second optical component 142 to pass through.

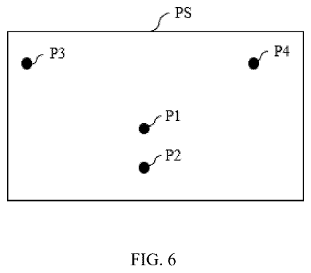

In order to further demonstrate that the present embodiment can improve the color uniformity of the projection image by the foregoing structure, please refer to FIG. 6 and Table 1. FIG. 6 illustrates the distribution positions of the plurality of measuring points P1˜P4 of the illumination system 1 on the projection image PS, and Table 1 explains the color differences (Δu′v′) of the measuring points P1˜P4 in response to the different arrangements of the polarization component 131. The color difference (Δu′v′) of Table 1 is defined as the absolute distance between a color location in the color coordinate corresponding to the measuring point and an average color location in the color coordinate corresponding to the average point of the measuring points. When the value of the color difference of the measuring point is lower, it represents that the color location in the color coordinate corresponding to the measuring point is closer to the average color location in the color coordinate corresponding to the average point of the measuring points and indicates that the color uniformity of the projection image PS is higher. From FIG. 6 and Table 1, it may be learned that in comparison with a control group in which there is no polarization component 131, the color differences (Δu′v′) of the measuring points P1˜P4 are exhibited as a descending trend by arranging the polarization component 131 at the place selected at least one from the place between the first light source module 111 and the light combining module 14, the place between the second light source module 112 and the light combining module 14, and the place between the third light source module 113 and the light combining module 14. Thus, it explains that the present disclosure arranges the polarization component in the travel path of the at least one part of the green light beam to convert the polarization state of the at least one part of the green light beam into the circular polarization state so that the light intensity distribution of the at least one part of the green light beam in the projection image may be changed. Hence, the changed light intensity distribution of the at least one part of the green light beam in the projection image approximates to the light intensity distribution of the red light beam in the projection image, and the color uniformity of the projection image is efficiently improved. In some embodiments, the color uniformity at the edge of the projection image may be improved by the arrangement of the polarization component of the present disclosure. In other embodiments, the color uniformity at the edge and the center of the projection image may be improved by the arrangement of the polarization component of the present disclosure.

TABLE 1

| | color difference (Δu′v′) | | | | |
|---|---|---|---|---|---|
| | | | | | Three |
| | | | | | polarization |
| | | | | | components |
| | | | | | respectively |
| | | | | | disposed |
| | | | | Two | between the first |
| | | | | polarization | light source |
| | | | | components | module and the |
| | | | | respectively | light combining |
| | | | | disposed between | module, between |
| | | Only one | Only one | the first light | the second light |
| | | polarization | polarization | source module | source module |
| | | component | component | and the light | and the light |
| | | disposed | disposed | combining module | combining module, |
| | | between the | between the | and between the | and between the |
| | | third light | first light | second light | third light |
| | Without | source module | source module | source module | source module |
| projection | polarization | and the light | and the light | and the light | and the light |
| image | component | combining module | combining module | combining module | combining module |
| P1 | 0.013 | 0.0034 | 0.0035 | 0.0022 | 0.0049 |
| P2 | 0.0136 | 0.0029 | 0.0027 | 0.0028 | 0.0031 |
| P3 | 0.0137 | 0.0098 | 0.01 | 0.0114 | 0.0122 |
| P4 | 0.0189 | 0.0131 | 0.0092 | 0.0088 | 0.0093 |

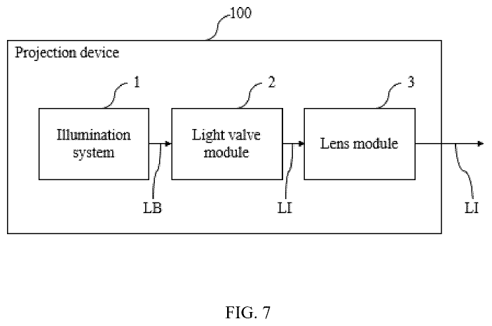

Based on the aforementioned embodiments, a projection device 100 including the illumination system 1 may be further provided. Please refer to FIG. 7, wherein the projection device 100 includes the illumination system 1 of one of the aforementioned embodiments, a light valve module 2 and a lens module 3. The illumination system 1 provides the illumination light beam LB. The light valve module 2 is disposed in the travel path of the illumination light beam LB and is configured to convert the illumination light beam LB into an image light beam L1. The lens module 3 is disposed in the travel path of the image light beam L1 and is configured to project the image light beam L1 out of the projection device 100 to form the projection image. In the present embodiment, the light valve module 2 may be a digital micromirror device (DMD) and includes a plurality of micromirrors, and the pixel length of each of the micromirrors may be less than 10 μm.

In view of the above descriptions, the illumination system and the projection device of the present disclosure has at least one advantage as follows: by arranging the polarization module in the travel path of the at least one part of the green light beam, the polarization state of the at least one part of the green light beam is converted into the circular polarization state after passing through the polarization module, and the at least one part of the green light beam enters the focusing component by the circular polarization state; by converting the polarization state of the at least one part of the green light beam, the light intensity distribution of the green light beam in the projection image is changed so that the light intensity distribution of the at least one part of the green light beam in the projection image approximates to the light intensity distribution of the red light beam in the projection image, thereby reducing the difference between the light intensity distribution of the green light beam in the projection image and the light intensity distribution of the red light beam in the projection image and improving the color uniformity of the projection image.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, configured to provide an illumination light beam,
comprising:
a light source module configured to provide a red light beam, a green light beam and a blue light beam;
a focusing component disposed in a travel path of the red light beam, a travel path of the green light beam and a travel path of the blue light beam, the focusing component configured to focus the red light beam, the green light beam and the blue light beam to generate the illumination light beam, and the focusing component provided with an ARC layer;
a polarization module disposed in the travel path of at least one part of the green light beam;
wherein a polarization state of the red light beam is a linear polarization state, and after the at least one part of the green light beam passes through the polarization module, a polarization state of the at least one part of the green light beam is converted into a circular polarization state, and the at least one part of the green light beam enters the focusing component by the circular polarization state.

2. The illumination system according to claim 1, wherein the polarization module is further disposed in the travel path of the blue light beam between the light source module and the focusing component, and after the blue light beam passes through the polarization module, a polarization state of the blue light beam is converted into the circular polarization state, and the blue light beam enters the focusing component by the circular polarization state.

3. The illumination system according to claim 1, further comprising a light combining module, and the light source module further comprises a first light source module and a second light source module, and the polarization module further comprises at least one polarization component; wherein
the first light source module is configured to provide a first red light beam, a first green light beam and a first blue light beam, and the second light source module is configured to provide a second red light beam, a second green light beam and a second blue light beam; the red light beam comprises the first red light beam and the second red light beam, the green light beam comprises the first green light beam and the second green light beam, and the blue light beam comprises the first blue light beam and the second blue light beam;
the light combining module is disposed in the travel path of the red light beam between the light source module and the focusing component, the travel path of the green light beam between the light source module and the focusing component and the travel path of the blue light beam between the light source module and the focusing component and the light combining module is configured to guide the first red light beam, the second red light beam, the first green light beam, the second green light beam, the first blue light beam and the second blue light beam to the focusing component, and the first light source module and the second light source module are respectively located on two adjacent sides of the light combining module;
the at least one polarization component is disposed between the first light source module and the light combining module and/or the second light source module and the light combining module.

4. The illumination system according to claim 3, wherein the at least one polarization component is further disposed in a travel path of the first blue light beam between the first light source module and the light combining module and/or a travel path of the second blue light beam between the second light source module and the light combining module, and after the first blue light beam and/or the second blue light beam passes through the at least one polarization component, a polarization state of the first blue light beam and/or a polarization state of the second blue light beam is converted into the circular polarization state, and the first blue light beam and/or the second blue light beam enters the focusing component by the circular polarization state.

5. The illumination system according to claim 3, wherein the light combining module further comprises a first optical component and a second optical component, the first optical component is located between the first light source module and the focusing component, the second optical component is located between the first optical component and the focusing component, and the second optical component is configured to reflect a first part of the blue light beam and a first part of the green light beam from the light source module and to allow a second part of the blue light beam and a second part of the green light beam from the light source module to pass through.

6. The illumination system according to claim 5, wherein the first optical component comprises a first region and a second region which are adjacent to each other; the first region is configured to reflect the second red light beam from the second light source module and to allow the first blue light beam and the first green light beam from the first light source to pass through, and the second region is configured to allow the first red light beam from the first light source module to pass through.

7. The illumination system according to claim 3, wherein the light source module further comprises a third light source module, wherein
the third light source module is configured to provide a third green light beam, the green light beam comprises the first green light beam, the second green light beam and the third green light beam, and the third light source module and the second light source module are on the same side of the light combining module;
the light combining module is configured to guide the third green light beam to the focusing component;
at least one of a place between the first light source module and the light combining module, a place between the second light source module and the light combining module, and a place between the third light source module and the light combining module is provided to dispose the at least one polarization component.

8. The illumination system according to claim 7, wherein the at least one polarization component is further disposed in a travel path of the first blue light beam between the first light source module and the light combining module and/or a travel path of the second blue light beam between the second light source module and the light combining module, and after the first blue light beam and/or the second blue light beam passes through the at least one polarization component, a polarization state of the first blue light beam and/or a polarization state of the second blue light beam is converted into the circular polarization state, and the first blue light beam and/or the second blue light beam enters the focusing component by the circular polarization state.

9. The illumination system according to claim 7, wherein the light combining module further comprises a first optical component and a second optical component, wherein the first optical component is located between the first light source module and the focusing component and the second optical component is located between the first optical component and the focusing component, and the second optical component is configured to reflect a first part of the blue light beam from the light source module and to allow a second part of the blue light beam from the light source module to pass through.

10. The illumination system according to claim 9, wherein the first optical component comprises a first region and a second region which are adjacent to each other; the first region is configured to reflect the second red light beam from the second light source module and to allow the first blue light beam and the first green light beam from the first light source to pass through, and the second region is configured to allow the first red light beam from the first light source module to pass through.

11. The illumination system according to claim 9, wherein the light combining module further comprises a third optical component located between the second optical component and the focusing component, and the third optical component is configured to reflect the third green light beam and to allow the red light beam and the blue light beam to pass through.

12. The illumination system according to claim 1, wherein the polarization module further comprises at least one polarization component, and the at least one polarization component is a quarter wave plate.

13. A projection device comprising:
the illumination system according to claim 1 providing the illumination light beam;
a light valve module disposed in a travel path of the illumination light beam and configured to convert the illumination light beam into an image light beam; and
a lens module disposed in a travel path of the image light beam and configured to project the image light beam out of the projection device.

14. The projection device according to claim 13, wherein the light valve module comprises a plurality of micromirrors, and a pixel length of each of the micromirrors is less than 10 μm.
